(19) United States
(12) Patent Application Publication
(10) Pub. No.: US 2024/0183040 A1
(43) Pub. Date: Jun. 6, 2024

(54) AMMONIA DEHYDROGENATION

(71) Applicant: COORSTEK MEMBRANE SCIENCES AS, Oslo (NO)

(72) Inventors: Dimitrios PAPPAS, Oslo (NO); Tor Svendsen BJØRHEIM, Oslo (NO); Christian KJØLSETH, Oslo (NO); Per Kristian VESTRE, Oslo (NO)

(21) Appl. No.: 18/281,661

(22) PCT Filed: Mar. 11, 2022
(86) PCT No.: PCT/EP2022/056413

§ 371 Date: Sep. 12, 2023

(30) Foreign Application Priority Data
Mar. 12, 2021 (GB) 2103454.1

(51) Int. Cl. C25B 1/02; B01D 53/32; B32B 18/00; C25B 9/05; C25B 9/23; C25B 9/67; C25B 11/052; C25B 11/067; C25B 11/077; C25B 13/07; C25B 15/08

(52) U.S. Cl. CPC C25B 1/02; B01D 53/326; B32B 18/00; C25B 9/05; C25B 9/23; C25B 9/67; C25B 11/052; C25B 11/067; C25B 11/077; C25B 13/07; C25B 15/08; B01D 2256/16

(57) ABSTRACT

A process for the production of compressed hydrogen in a membrane reactor, said membrane reactor comprising a first zone separated by a proton conducting membrane from a second zone, said first zone having a gas inlet and a product outlet and said second zone having a product outlet; said process comprising; a. feeding a gas comprising ammonia to said first zone via said gas inlet, and allowing a reaction to take place in said first zone so that hydrogen and nitrogen are formed; b. applying an electric field over said proton conducting membrane; c. allowing hydrogen to dissociate into electrons and protons to selectivity pass through the proton conducting membrane to said second zone where protons and electrons recombine to form hydrogen in the second zone; wherein the membrane reactor comprises a pressure regulator at said product outlet from said second zone so that, in operation, the partial pressure of hydrogen in the second zone is higher than the partial pressure of hydrogen in the first zone.

This invention relates to a process for obtaining, and preferably compressing, hydrogen from ammonia. In particular, the invention uses a proton conducting membrane to separate hydrogen generated from ammonia and create hydrogen pressure on the permeate side of the membrane. An electric field is applied to the membrane to encourage proton transport across the proton conducting membrane and joule heating during the application of the electric field can be used to supply heat for the endothermic ammonia dehydrogenation process.

### BACKGROUND OF THE INVENTION

Hydrogen can be extracted from hydrogen-containing molecules, such as by dehydrogenation of ammonia:

2NH₃(g)=N₂(g)+3H₂(g) (1)

Reaction (1) is endothermic (ΔH_{298K}=45.94 kJ mol⁻¹) and is typically operated in the temperature range 400-600° C. using a dehydrogenation catalyst. At standard pressure the reaction proceeds spontaneously at temperatures >183° C., however achieving high conversion requires temperatures >400° C. to overcome both thermodynamic limitations and kinetic barriers. The hydrogen can be separated downstream from the nitrogen hydrogen mixture using e.g. pressure swing absorption (PSA). Finally, the hydrogen can be compressed using available compressor technologies such as piston or diaphragm mechanical compressors or using electrochemical/chemical compressors.

Alternatively, hydrogen separation can be included in dehydrogenation systems using hydrogen selective membranes. Such a system consists of two process steps. A first step includes a dehydrogenation catalyst which converts ammonia to hydrogen and nitrogen according to Eq. 1 at temperatures >400° C. The hydrogen and nitrogen mixture are then fed to a gas separation membrane.

The vast majority of such membranes utilize metallic hydrogen permselective Pd or Pd in combination with Ag, Cu. This enables operation at lower temperatures while still maintaining a high hydrogen recovery.

The drawback for the Pd based membranes is the significant partial pressure difference of hydrogen needed across the membrane, pH₂(retentate)>pH₂ (permeate). The driving force for hydrogen transport is the chemical potential gradient of hydrogen across the membrane. When the hydrogen partial pressure on the retentate side is low, high hydrogen recovery will be challenging.

It follows that the final pressure of hydrogen in the permeate will always be low and further pressurization of hydrogen requires large compressors on a volumetric basis. This is demanding and adds complexity to the overall process and inhibits high energy efficiencies.

A further challenge with coupling a catalytic reactor with Pd-based membranes is that heat management is more complex as the heat needed for the both the endothermic dehydrogenation reaction and the high temperature operation of the Pd-based membranes needs to be supplied externally.

Alternatively, electrochemical dehydrogenation of ammonia can produce high-purity hydrogen at near ambient conditions and with high conversion rates. Aqueous alkali electrolytes have been demonstrated for this purpose, however a challenge is that they require high operation potentials, which implies poor energy efficiency. Another challenge has been that they suffer from catalyst deactivation over time.

A solid-acid-based electrochemical cell in combination with a bi-layered anode, comprising a novel Ru—Cs/CNT thermal-cracking catalyst layer and a Pt based hydrogen electrooxidation catalyst layer has also been utilized to separate hydrogen. Humidified dilute ammonia was supplied to the anode and humidified hydrogen was fed to the cathode. Although utilizing a novel thermal-cracking catalyst, the ammonia-to-hydrogen conversion reached only rates of ˜3.5% at OCV followed by an increase to <15% under applied load (Joule 4, 2338-47). Ammonia has been used as a hydrogen source for direct fuel cell operation, where ammonia decomposes according to Eq. (1).

As ammonia dehydrogenation catalysts several metals have been investigated and the catalytic activity decrease in the order: Ru>Ni>Rh>Co>Ir>Fe>Pt>Cr>Pd>Cu>>Te, Se, Sb. Ru is clearly the most active metal catalyst, and most reports rely on the use of Ru based catalyst. Further Ce-promoted Ru supported on graphite structures such as carbon nanotubes show catalytic activities at temperatures from about 250° C. However, large use of Ru is not feasible due to its high cost and scarcity. Ni-based catalysts are more suitable for industrial applications. Ni is supported on an oxide such as Al₂O₃, Gd₂O₃ or Y₂O₃ and the catalytic activity can be additionally improved by CeO₂ as a promoter. Ni-based catalyst achieve full ammonia conversion >600° C. (e.g. Okura et al. ChemCatChem 8, (2016)).

It is generally accepted that the hydrogen compressor technology will not be able to meet future infrastructure demands in a cost-effective manner. The hydrogen compressors used today face considerable wear due to the usage of technology with moving parts. Research has shown that for piston pumps the piston sealing ring fails due to non-uniform pressure distribution, and failure of pistons is due to server impact.

Diaphragm compressors are prone to shorter lifetimes due to contaminations/debris in the hydrogen gas and improper priming procedures when restarting a compressor after stopping. The operation pressure is high enough to cause local plastic deformation around trapped hard particles leaving residual stresses that reduce the fatigue life of the diaphragm.

Previously, WO2018/069546 describes electrochemical hydrogen separation in steam reforming. However, there is no suggestion that such a process might work on ammonia. It will be appreciated that ammonia is caustic and hence a much more challenging reactant than a hydrocarbon. There is no suggestion in '546 that the membrane reactor described therein might be able to dehydrogenate ammonia.

The present inventors have appreciated that electrochemical hydrogen compressors will increase the reliability/availability over mechanical compressors as they operate without any moving parts. There remain challenges in designing these electrochemical compressors, such as their energy efficiencies.

The invention solves three separate challenges simultaneously which have hampered the commercial deployment of a range of chemical processes by introducing a galvanically driven protonic membrane compressor. In particular, the protonic membranes of the invention:
1. Will remove hydrogen from the reaction chamber and shift a limited (thermodynamically and/or kinetically) process towards higher conversion towards the desired product;
2. Will provide heat to an endothermic reaction process; and
3. Will simultaneously compress the hydrogen to a desired pressure at the permeate side of the membrane.

Moreover, the high selectivity of the membrane allows only for hydrogen to pass through. The hydrogen produced is therefore of high purity; a final purification stage is therefore not needed.

The protonic membrane of the invention enables operation in steam-reach environments such as ammonia-steam mixtures as a high water content increases the proton conductivity and as such of the performance of the membrane.

The combination of these four (optionally 5) effects in a single process results in high energy efficiency. More specifically this yields distinct advantages. The conversion and yield of a chemical process can be increased to a commercial attractive level and the by-product, hydrogen, has an attractive partial pressure and purity for further usage. Finally, the joule heat produced enables operation of the overall process in an autothermal state.

### SUMMARY OF THE INVENTION

Thus, viewed from one aspect, the invention provides a process for the production of compressed hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone via said gas inlet, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein the membrane reactor comprises a pressure regulator at said product outlet from said second zone so that, in operation, the partial pressure of hydrogen in the second zone is higher than the partial pressure of hydrogen in the first zone.

Viewed from another aspect, the invention provides a process for the production of hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein Joule heating which occurs during the application of the electric field over said proton conducting membrane is used to heat the first zone.

Viewed from another aspect, the invention provides a process for the production of compressed hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein the membrane reactor comprises a pressure regulator at said product outlet from said second zone so that, in operation, the partial pressure of hydrogen in the second zone is higher than the partial pressure of hydrogen in the first zone; and
wherein Joule heating which occurs during the application of the electric field over said proton conducting membrane is used to heat the first zone.

In a preferred embodiment, the energy required to heat the first zone to the reaction temperature is derived exclusively from Joule heating which occurs during the application of the electric field over said proton conducting membrane. In a more preferred embodiment, the energy required for isothermal operation of the membrane reactor is derived exclusively from Joule heating.

In a preferred embodiment, the energy required to heat the first zone to the reaction temperature is derived from Joule heating which occurs during the application of the electric field over said proton conducting membrane and from heat generated during the compression of hydrogen on the permeate side of the proton conducting membrane.

The gas added to the first zone comprises ammonia, e.g. consists of ammonia. In an additional preferred embodiment, the gas added to the first zone comprises, e.g. consists of, a mixture between ammonia and water (i.e. as steam).

Viewed from another aspect the invention provides a membrane reactor comprising a first zone separated by a membrane electrode assembly from a second zone, said first zone having a gas inlet and a product outlet and said second zone having a product outlet wherein said second zone product outlet is provided with a pressure regulator;
a power source adapted to pass an electric field over the membrane electrode assembly; and wherein said membrane electrode assembly comprises, in the following layer, order:
1) a supporting electrode layer comprising a metal-oxide composite of formula

Ni-AZrₐCe_{b}Acc_{c}O_{3-y} (I)
wherein the volumetric or weight fraction if Ni is between more than 0 and 0.8, such as 0.2 to 0.8, e.g. 0.4 based on the weight of the metal-oxide composite;
2) a proton conducting membrane layer comprising

AZrₐCe_{b}Acc_{c}O_{3-y} (II)
3) a second electrode layer comprising a metal-oxide composite of formula

Ni-AZrₐCe_{b}Acc_{c}O_{3-y} (III)
wherein the volumetric or weight fraction if Ni is between more than 0 and 0.8, such as 0.2 to 0.8, e.g. 0.4 based on the weight of the metal-oxide composite; wherein, for each layer independently, A is Ba, Sr or Ca or a mixture thereof; the sum of a+b+c equals 1;
b is 0-0.75;
c is 0.05-0.5;
Acc is Y, Yb, Gd, Pr, Sc, Fe, Eu, In or Sm
or a mixture thereof; and y is a number such that formula (II), is uncharged, e.g. 3-y is 2.75 to 2.95.

The hydrogen extracted from the first zone shifts the reaction equilibrium towards the product side.

Preferably the MEA is (1) a supporting electrode layer comprising a Ni composite of formula Ni—BaCe_{0.1}Zr_{0.7}Y_{0.1}Yb_{0.1}O_{3-y}; (II) a proton conducting membrane layer comprising BaCe_{0.1}Zr_{0.7}Y_{0.1}Yb_{0.1}O_{3-y}; (III) a second electrode material comprising a Ni composite of formula Ni—BaCe_{0.1}Zr_{0.7}Y_{0.1}Yb_{0.1}O_{3-y}.

### DETAILED DESCRIPTION OF THE INVENTION

The present invention concerns a process for the dehydrogenation of ammonia to form hydrogen and nitrogen. In particular, the invention uses a proton conducting membrane to simultaneously remove hydrogen from the reaction mixture, e.g. an ammonia, nitrogen and hydrogen mixture. The invention also enables the compression of the removed hydrogen and uses Joule heating in the proton conducting membrane to heat the retentate side of the membrane reactor where the dehydrogenation reaction occurs. The first zone is preferably provided with a dehydrogenation catalyst which, in a further preferred embodiment, also forms an electrode on the proton conducting membrane.

For hydrogen production through the dehydrogenation of ammonia, our process solves the problems of reaction, separation, compression and heat management in one single step.

The process of the invention takes place in a membrane reactor in which the proton conducting membrane separates a first zone (the retentate side of the membrane) and a second zone (the permeate side of the membrane).

In a preferred embodiment, the first zone is provided with a catalyst to encourage the dehydrogenation process. The second zone comprises an outlet for the gas that passes through the proton conducting membrane. The outlet preferably comprises a pressure regulator that enables compression of the hydrogen within the second zone.

In the claimed process, ammonia (or ammonia and water) is introduced into the first zone and an electric field is applied across the proton conducting membrane. As the ammonia is dehydrogenated in the first zone, the application of the electric field across the proton conducting membrane encourages the hydrogen that forms to dissociate into protons to pass through the proton conducting membrane.

The heat generated by the passing of current through the proton conducting membrane is used to encourage the endothermic reforming reaction in the first zone.

### Reactant

Ammonia is added to the membrane reactor in the first step of the process of the invention. The term reactant is used herein to refer to the ammonia gas which is dehydrogenated into hydrogen and nitrogen in the first zone of the membrane reactor. Ammonia is dehydrogenated according to the equation:

2NH₃=3H₂+N₂

The conversion of reactant achieved in this type of dehydrogenation process is preferably at least 50 wt %, preferably at least 70 wt. %, e.g. 80 wt. % or more. The yield therefore of the products is preferably at least 50%, preferably at least 70%, e.g. 80% or more.

Moreover, it is preferred if the selectivity is preferably at least 70 wt. %, preferably at least 90 wt. %, e.g. at least 95 wt. %. This means that the formed decomposed product is at least 95 wt. % pure, i.e. there are almost no impurities present at all. The only compounds present in the first zone are unconverted reactant, nitrogen and hydrogen (and possibly water).

In another preferred embodiment the gas fed to the first zone is a mixture of ammonia and water. It will be appreciated that water is not considered as a reactant rather ammonia is often supplied as a water solution and hence it is important that the membrane reactor of the invention can operate using this common feedstock. Ammonia or its decomposed products, nitrogen or hydrogen, do not react at all with water however water (steam) will increase the proton conductivity of the proton conducting membrane, as it increases the concentration of charge carriers through hydration. The presence of water may also allow co-ionic conductivity leading to some oxygen transport in opposite direction to the protons over the electrolyte, in the case where water is present at the permeate side.

It is preferred that the concentration of water in the ammonia water mixture that is feed to the membrane reactor is at least 1 vol. %, preferably at least 10 vol. %, e.g. 30 vol. % or more, such as up to 70 vol % or 80 vol %.

In a preferred embodiment it is preferred if the aqueous ammonia solution contains less than 35 vol. % of ammonia such as 10 to 35 vol. % ammonia. Ammonia solutions comprising less than 35 vol. % ammonia are considered safe to transport and comply with International transport regulations. It is advantageous therefore that this material can be used directly in the membrane reactors of the invention without the need for further steps.

In another preferred embodiment the feed gas is a mixture of ammonia and water in a ratio 1:0.01 to 1:5 molar.

When the process of the invention involves an aqueous ammonia feed to the membrane reactor, the dehydrogenation reaction may still proceed with high conversion. Conversion of at least 95%, preferably at least 97%, e.g. 99% or more of the ammonia to nitrogen and hydrogen are possible. This means that almost all the ammonia fed to the reactor is converted.

### Proton Conducting Membrane

The proton conducting membrane (which may also be called the hydrogen conducting membrane or hydrogen transport membrane) is an important feature of the claimed process. It is critical that the membrane reactor is provided with a proton conducting membrane which selectively allows hydrogen, in the form of protons, to leave the first zone of the membrane reactor through the proton conducting membrane but does not allow the ammonia, water, nitrogen or any by-products to pass through.

The proton conducting membrane separates the first zone in which a dehydrogenation process takes place (i.e. in which the feed and, if present, dehydrogenation catalyst come together) from the second zone which will contain hydrogen which passes through the proton conducting membrane and any means desired to remove that hydrogen.

The proton conducting membrane must be of a material that can selectively transport hydrogen in ionic form as protons. Once the protons have passed through the proton conducting membrane hydrogen reforms on the permeate side of the proton conducting membrane.

It is preferred if the proton conducting membrane material is chemically inert and stable at temperatures between 400 and 1000° C. The proton conducting membrane should be chemically inert in atmospheres containing gases such as ammonia, water, nitrogen and hydrogen. The proton conducting membrane material should not promote nitride formation, which typically means that the material should be basic and also should have a surface that does not catalytically promote formation of nitrides.

One group of materials that meets these requirements is some mixed metal oxides, and it is preferred if the proton conducting membrane material used in the proton conducting membrane comprises a mixed metal oxide. Ideally, the transport membrane will possess a proton conductivity of at least 1×10⁻³ S/cm. The proton conductivity of the proton conducting membrane of the invention is preferably at least 1.5×10⁻³ S/cm, especially at least 5×10⁻³ S/cm. Proton conductivities up to 40×10⁻³ S/cm are possible.

A range of mixed metal oxides may be suitable as proton conducting membranes, including acceptor doped perovskites (such as Y-doped BaZrO₃ and Y-BaCeO₃).

Preferred membrane materials therefore include perovskites according to the general formula (IV)

A′B_{1-q}B′_{q}O_{3-z} (IV)
wherein A′=La, Ba, Sr or Ca or a mixture thereof;
B═Ce, Zr, Hf, Ti, In, Tb, Th or Cr or a mixture thereof;
B′=Y, Yb, Gd, Pr, Sc, Fe, Eu, In or Sm or a mixture thereof:
z is a number sufficient to neutralize the charge; and
0.01≤q≤0.5. It will be appreciated that B and B′ are different metals.

In one embodiment element B can represent more than one element, such as Zr and Ce.

A preferred formula is therefore

A′ZrₚCeᵣB′_{q}O_{3-z} (IV)
wherein A′=La, Ba, Sr or Ca;
B′=Y, Yb, Gd, Pr, Sc, Fe, Eu, In or Sm or a mixture thereof:
z is a number sufficient to neutralize the charge;
p+q+r=1
and
0.01≤q≤0.5.

Variables p and r are preferably 0.01 to 0.9.

In one embodiment element B′ is Y.

In one embodiment element B′ can represent more than one element, such as Y and Yb.

A preferred formula is therefore

A′B_{1-q}(Y_{1-w}Yb_{w})_{q}O_{3-z} (V)
where 0.01≤w≤0.99 and other variables are as hereinbefore defined.

A preferred formula is also

AZrₚCeᵣ(Y_{1-w}Yb_{w})_{q}O_{3-z} (VI)
wherein A′=La, Ba, Sr or Ca;
w is 0.01≤w≤0.99
z is a number sufficient to neutralize the charge;
p+q+r=1
and
0.01≤q≤0.5.

Variables p and r are preferably 0.01 to 0.9.

An ideal mixed metal oxide comprises the following components:
Ln, Zr, Acc and O, more preferably ions of
Ln, Zr, Ce, Acc and O;
wherein Ln is Ba, Sr or Ca or a mixture thereof; and Acc is a trivalent transition metal or trivalent lanthanide metal such as Y, Yb, Gd, ,Pr, Sc, Fe, Eu,, In, or Sm or a mixture thereof.

More specifically, a preferred oxide comprises a mixed metal oxide of formula (I)

AZrₐCe_{b}Acc_{c}O_{3-y} (I)
wherein A is Ba, Sr or Ca or a mixture thereof;
the sum of a+b+c equals 1:
b is 0-0.75, such as 0.1 to 0.75;
c is 0.05-0.5;
Acc is a trivalent transition metal or lanthanide metal, such as Y, Yb, Gd, Pr, Sc, Fe, Eu, Pr, In, or Sm or a mixture thereof; and
y is a number such that formula (I) is uncharged, e.g. 3-y is 2.75 to 2.95.

In particular, it is preferred if A is Ba. It is preferred if Acc is Y orYb or a mixture thereof, especially Y or Y and Yb.

In a further preferred embodiment therefore the membrane comprises a mixed metal oxide of formula (II) or (II′):

BaZrₐCe_{b}Y_{c}O_{3-y} (II′) or

SrZᵣₐCe_{b}Y_{c}O_{3-y} (II′)
wherein the sum of a+b+c equals 1:
b is 0-0.75 such as 0.1 to 0.75;
c is 0.05-0.5; and
y is a number such that formula (I) is uncharged, e.g. 3-y is 2.75 to 2.95.

Where b is 0 there are no Ce ions and the formula reduces to:

BaZrₐY_{c}O_{3-y} (III′) or

SrZrₐY_{c}O_{3-y} (III′)
wherein the sum of a+c equals 1:
c is 0.05-0.5; and
y is a number such that formula (I) is uncharged, e.g. 3-y is 2.75 to 2.95.

A preferred ceramic comprises ions selected from the group consisting of Ba, Ce, Zr, Y, Yb and O. A highly preferred ceramic mixed metal oxide is of formula BaZr_{0.7}Ce_{0.2}Y_{0.1}O_{3-δ} or BaZr_{0.1}Ce_{0.7}Y_{0.1}Yb_{0.1}O_{3-y}.

It is preferred if b+c sums to 0.1 to 0.7, such as 0.2 to 0.4.

It is preferred if b is 0.1 to 0.75, such as 0.1 to 0.4.

It is preferred if c is 0.05 to 0.4., such as 0.1 to 0.2.

Another highly preferred option is formula (X)

BaZrₐCe_{b}Y_{c}Yb_{d}O_{3-y} (X)
wherein the sum of a+b+c+d equals 1:
b is 0.05-0.75
c is 0.05-0.45
d is 0.05-0.45; and
y is a number such that formula (I) is uncharged, e.g. 3-y is 2.75 to 2.95.

Another highly preferred option is formula (XI)

BaZrₐCe_{b}Y_{c}Yb_{d}O_{3-y} (X)
wherein the sum of a+b+c+d equals 1:
b is 0.05-0.75
c is 0.05-0.25
d is 0.05-0.25; and
y is a number such that formula (I) is uncharged, e.g. 3-y is 2.75 to 2.95.

It is preferred if the ceramic material of the proton conducting membrane adopts a perovskite crystal structure.

### Preparation of the Membrane

The metal ions required to form the ceramic mixed metal oxide that forms the proton conducting membrane can be supplied as any convenient salt of the ion in question. In order to form the proton conducting membrane, a sintering process is required. During the sintering process, the salts are converted to the oxide so any salt can be used. The amount of each component is carefully controlled depending on the target end mixed metal oxide.

Suitable salts include sulphates, nitrates, carbonates and oxides of the ions. The use of sulphates is preferred for the alkaline earth metal component, especially BaSO₄. The use of CeO₂ is preferred for the cerium ion source. The use of ZrO₂ is preferred as the Zr source. The use of oxides is preferred for the Acc ion source. Y₂O₃ is preferred as the Y ion source. Yb₂O₃ is preferred as the Yb ion source.

Particles of the precursor materials can be milled to form a powder mixture.

It is preferred if the reactants needed to make the proton conducting membrane layer are prepared as a slurry in an aqueous or non-aqueous solvent (such as an alcohol). The use of water is preferred. The relative amounts of the reactants can be carefully measured to ensure the desired mixed metal oxide stoichiometry. Essentially all the metal oxide present becomes part of the sintered membrane body and all other components are removed thus the amounts of each component required to develop the desired stoichiometry can be readily calculated by the skilled person.

As well as the metal salts required to make the mixed metal oxide, the slurry used to make the proton conducting membrane may comprise other components present to ensure the formation of the proton conducting membrane. Such components are well known in the art and include binders, rheology modifiers, dispersants and/or emulsifiers or other additives to ensure that the proton conducting membrane forms and remains solid and intact until the sintering process. Additives therefore act as a kind of adhesive sticking the metal salt particles together to form a layer.

Suitable additive compounds include ammonium polyacrylate dispersant and acrylic emulsions. The content of additive such as emulsifier/dispersant may be between 0 to 10 wt %, such as 1 to 5 wt % of the mixture as a whole. Suitable binders would be methyl cellulose, acrylic emulsions, and starches. The content of such binders may be between 0 to 10 wt % such as 1 to 5 wt % of the mixture as a whole.

Water is the preferred solvent and may form 5 to 20 wt % of the slurry used to form the proton conducting membrane. The metal components required to form the composite may form 50 to 80 wt % of the slurry.

This slurry can be extruded, applied to a mould etc. to form the proton conducting membrane and subsequently dried to leave a solid but unsintered green body as a precursor to the proton conducting membrane. It will be appreciated that any additives present are preferably organic as these will decompose during the sintering process. It will be appreciated that the green layers described herein are precursors of the actual proton conducting membrane. The membrane is formed upon sintering, described in detail below.

The proton conducting membrane used in the membrane reactor may have a thickness of 1 to 500 micrometers, such as 10 to 150 micrometres. The thickness of the proton conducting membrane is therefore the distance which the protons need to pass across to transmit the proton conducting membrane.

Some proton conducting membranes, especially those having a thickness in the lower end of the range, will require a structural support, while membranes with thickness in the higher end of the indicated thickness range may be “self-supported”.

### Support

It may be necessary to use a support to carry the proton conducting membrane. The support should be inert, porous and capable of withstanding the conditions within the membrane reactor. In one embodiment, the support may form an electrode.

The following are important properties for the support:
Porous
Chemically compatible with the proton conducting membrane—does not react to form a secondary insulating phase;
Mechanically compatible with the proton conducting membrane—thermal expansion coefficient should preferably match that of the proton conducting membrane.

In one embodiment, the support will be an inert metal oxide such as an alkali metal oxide or silica or alumina. Such supports are well known in this field. In general, the particle size in the support should be greater than the particle size in the membrane, e.g. at least 200 nm higher. Supports may be 2-300 μm to 1 mm or more in thickness.

The design of the support material depends on the design of the whole membrane reactor. Typically the proton conducting membrane, and hence any support/electrodes, will be planar or tubular. The term tubular may be used herein to designate a proton conducting membrane that is a hollow cylinder with two open ends, or alternatively it may be a plurality of smaller channels forming a “honeycomb structure” or it can take the shape of a “test tube”, i.e. a cylinder with hemispherical end portion but open at the other end.

In a tubular embodiment, porous support tubes can be extruded. The support can then be heat treated to yield the desired mechanical strength. In a planar embodiment the support material can be tape cast, also followed by heat treatment to yield the desired mechanical strength. In a tape casting process, a slurry of the material is typically spread evenly onto a flat horizontal surface by means of a doctor blade. After drying, the thin, film formed can be removed, cut to the desired shape and fired.

To manufacture a support structure either as a planar support or as a tube, an ink of the desired support material can be produced either using water as a solvent or an organic solvent, optionally as well as stabilizing agents. To have controlled porosity, a pore filler material is often used, e.g. carbon black. The ink can then be tape cast or extruded. The support is subsequently fired to a desired firing temperature, such as 600 to 1650° C. to yield mechanical robust supports with a desired porosity.

In a complex design embodiment, the porous support tubes or a porous electrode support can be prepared by gel casting. A mould is prepared of the desired structure. A solution of the desired material is then prepared and poured into the mould. After the solution is gelified the mould is removed. The support is subsequently fired to a desired firing temperature, such as 600 to 1650° C. to burn out the organic residue and to yield mechanically robust supports with a desired porosity.

### Electrodes

In order to apply an electric current across the proton conducting membrane, this needs to be provided with an anode and a cathode. Conveniently, porous electrodes form on either side of the proton conducting membrane. Thus a three layer structure can be formed comprising a first electrode layer, proton conducting membrane layer and a second electrode layer.

In some embodiments, one or both electrodes can act as a support for the proton conducting membrane. In some embodiments, the electrode present within the first zone can also act as a dehydrogenation catalyst.

Preferred electrodes, which are exposed to the first zone of the reactor, should have following characteristics:
Electronic percolation
Catalytic activity towards hydrogen dissociation
Catalytic activity towards ammonia decomposition into nitrogen and hydrogen
Porous microstructure to allow gas diffusion of hydrogen to and from triple phase boundaries and avoid concentration polarization due to accumulation of larger nitrogen molecules or steam
Chemical compatibility with catalyst, if applied, under reactor operation

A preferred structure comprises a supporting electrode layer comprising a Ni-metal-oxide composite;
a proton conducting membrane layer comprising a metal-oxide composite
a second electrode layer comprising a Ni-metal-oxide composite.

The electrode can be a single phase or composite with multiple phases. Some potential candidate materials include the following groups:
Metals/metal alloys (such as Ni, Fe, Ru, Pt and Pd alloys)
Mixed metal oxides such as La₁₋ₓSrₓCr_{1-y}Mn_{y}O₃ (where x and y are 0-1)
Mixed metal oxides such as LaxSr₁₋ₓTiO₃ (where x and y are 0-0.5)

It is preferred if the electrode has catalytic properties for the ammonia dehydrogenation process. Such materials are:
Ni
Fe

The second electrode is not exposed to the first zone in the membrane reactor and is preferably positioned in the second zone. It may be selected from a wider range of materials known to those skilled in the art.

In one embodiment the electrodes are conveniently both of the same composition.

In a preferred embodiment, the electrodes required form part of a membrane electrode assembly (MEA) comprising two electrode layers and the proton conducting membrane (also called a membrane layer or electrolyte layer herein).

The electrodes in this embodiment may be of the same composition, especially using a material that both exhibits activity for ammonia dehydrogenation and hydrogen disassociation/association. Such a material may comprise Ni. Most conveniently, the electrodes are Ni composites comprising Ni and the material used in the proton conducting membrane. Further conveniently, the catalytic activity towards ammonia dehydrogenation improves when the proton conducting membrane acts as a support for Ni as it increases the hydrogen activity.

The membrane electrode assembly (MEA) can be fabricated with such techniques generally known to those skilled in the art of fuel cells and inorganic gas separation membranes.

### First Electrode

The first electrode layer tends to be thicker than the electrolyte or second electrode layer as it preferably supports the MEA. It is therefore preferred if the MEA does not contain a separate support layer. The MEA should be supported by the first electrode layer.

The first electrode layer may have a thickness of 250 microns to 2.0 mm, such as 500 microns to 1.5 mm, preferably 500 microns to 1.2 mm.

The first electrode layer is preferably produced in the green state, i.e. it is not sintered/densified before the application of the electrolyte layer thereto.

The MEA may be in cylindrical form or planar form (or any other layered structure as required). Ideally however, the MEA is planar or cylindrical, especially cylindrical. Either anode or cathode can be present at the centre of the cylinder and the first electrode layer can be either anode or cathode.

The method for the preparation of the first electrode layer is quite flexible. In order to prepare the first electrode layer, a mould or support may be used. Thus, the first electrode layer may be deposited on a cylindrical or planar supporting mould. After the layer is formed, the mould can be removed leaving the first electrode layer. Alternatively, the first electrode layer could be extruded to form a cylinder or planar support.

The first electrode layer may be prepared by methods including extrusion, slip casting, injection moulding, tape casting, wet and dry bag isopressing, and additive manufacturing.

The length/width of the first electrode layer is not critical but may be 10 to 50 cm. In tubular form, the inner tube diameter may be 2.0 mm to 50 mm, such as 2.0 to 15.0 mm. By inner tube diameter means the diameter is measured from the inside of the layer and excludes the thickness of the actual tube.

The mixture used to manufacture the supporting electrode material comprises ceramic powders and optional additives such as emulsifiers, pore formers, binders, rheology modifiers etc. in order to allow the formation process.

The first electrode is preferably produced from a slurry comprising ceramic components, binders and rheology modifiers.

After sintering, the first electrode may comprise a mixed metal oxide so the mixture used to prepare it should comprise precursors to the desired mixed metal oxide. A preferred mixed metal oxide is the same as ones taught above for the proton conducting membrane.

The first electrode material is a composite material in which the ceramic mixed metal oxide, ideally the mixed metal oxide described above, is combined with NiO. On sintering and after passing a reducing gas to reduce NiO to Ni at a temperature between 500 and 1100° C. this creates a porous structure through which the likes of hydrogen can pass. In a preferred embodiment therefore, the first electrode material, is a Ni composite of a metal oxide as described above in connection with the proton conducting membrane.

The compounds required to make the target mixed metal oxide of the first electrode can therefore be combined with a nickel compound to form a composite structure. The Ni is preferably added in the form of its oxide.

The fractional amount of Ni compound in the Ni:mixed metal oxide composite after sintering may be more than 0 to 0.8, preferably 0.2 to 0.8 on a volumetric basis or weight basis (with the mixed metal oxide therefore forming less than 1 to 0.2). The amount of Ni compound in the composite after sintering may be more than 0 to 80 wt %, preferably 20 to 80 wt %, such as 40 to 80 wt % or 55 to 80 wt % based on the weight of the composite. Ideally, the nickel compound(s) forms at least 50 wt %, such as at least 60 wt % of the green electrode layer. Ideally, the Ni component forms at least 50 wt % such as at least 60 wt % of the sintered electrode.

The metal ions required to form the ceramic mixed metal oxide that forms the electrode layer can be supplied as any convenient salt of the ion in question as described above in connection with the proton conducting membrane.

Particles of the reactant precursor materials can be milled to form a powder mixture. Once formed, this powder mixture can be combined with nickel oxide to form a powder mix.

It is preferred if the reactants and the Ni oxide needed to make the first electrode layer are prepared as a slurry in an aqueous or non-aqueous solvent (such as an alcohol). The use of water is preferred. The relative amounts of the reactants can be carefully measured to ensure the desired mixed metal oxide stoichiometry and the desired Ni content in the final product after sintering. Essentially all the metal oxide/NiO present becomes part of the sintered electrode body and all other components are removed thus the amounts of each component required to develop the desired stoichiometry can be readily calculated by the skilled person.

As well as the metal salts required to make the mixed metal oxide and the nickel oxide composite, the slurry used to make the first electrode layer may comprise other components present to ensure the formation of an electrode layer. Such components are well known in the art and include binders, rheology modifiers, dispersants and/or emulsifiers or other additives to ensure that the electrode support forms and remains solid and intact until the sintering process. Additives therefore act as a kind of adhesive sticking the metal salt particles together to form a layer.

Suitable additive compounds include ammonium polyacrylate dispersant and acrylic emulsions. The content of additive such as emulsifier/dispersant may be between 0 to 10 wt %, such as 1 to 5 wt % of the mixture as a whole. Suitable binders would be methyl cellulose, acrylic emulsions, and starches. The content of such binders may be between 0 to 10 wt % such as 1 to 5 wt % of the mixture as a whole.

Water is the preferred solvent and may form 5 to 20 wt % of the slurry used to form the supporting electrode layer. The metal components required to form the composite may form 50 to 80 wt % of the slurry.

It is preferred if the first electrode, after sintering, is a composite of formula Ni-AZrₐCe_{b}Acc_{c}O_{3-y} where the fraction of Ni in the Ni=AZrₐCe_{b}Acc_{c}O_{3-y} composite is 0.2 to 0.8 on a volumetric orweight basis and the variables are as herein before defined (formula (I)).

Alternatively viewed, it is preferred if the second electrode, after sintering, is a composite of formula Ni-AZrₐCe_{b}Acc_{c}O_{3-y} where the fraction of Ni in the Ni-AZrₐCe_{b}Acc_{c}O_{3-y} composite is 0.2 to 0.8 on a volumetric or weight basis and the variables are as herein before defined (formula (I)).

Once the first electrode is formed the proton conducting membrane precursor materials can be applied to it. Any method can be used to apply the proton conducting membrane to the first electrode. It will be appreciated that these two layers should be adjacent without any intermediate layer.

Several thin film techniques can be used to deposit membranes on supports. These include, for example:
Screen printing;
Chemical vapour deposition techniques (CVD);
Spray deposition methods—e.g. ultrasonic spray deposition (USD);
Electrophoretic deposition;
Spin and dip coating;
Slurry coating; and
Impregnation.

Screen printing, spray deposition and spin/dip coating are preferred techniques. Screen printing is easy to upscale and can readily achieve thicknesses down to 10 μm.

In a planar embodiment the membrane is preferably deposited on a porous support using a screen printing technique.

### Second Electrode

The second electrode typically has a similar structure to that of the first electrode. It is ideally therefore a composite of a mixed metal oxide and Ni oxide. Any method can be used to apply the second electrode layer to the electrolyte layer. It will be appreciated that these two layers should be adjacent without any intermediate layer. Methods include dip coating, spray coating, hand wash, pulsed laser deposition, physical vapor deposition, and screen printing.

The second electrode layer may have a thickness of 10 to 400 microns, such as 30 to 100 microns.

It will be appreciated that the second electrode layer need not cover the whole of the electrolyte layer. The dimensions of the second electrode layer can be controlled by the person skilled in the art.

The second electrode layer is preferably provided as a green ceramic slurry. For the second electrode slurry, the weight fraction of metallic powders to spray vehicle is preferably between 30 and 85% by weight, preferably from 40 to 76%. The solvent for the second electrode slurry may be organic or aqueous but is preferably aqueous so as to minimize re-dissolution of the electrolyte layer and/or swelling of the electrolyte layer both of which would lead to catastrophic failure of the membrane prior to further processing.

Again, the ceramic compounds used to form the second electrode layer are ideally mixed with additives including emulsifiers, rheology modifiers, binders and so on to ensure a good layer application to the electrolyte layer. The viscosity of the slurry is controlled to aid deposition. The viscosity required is a function of the nature of the application technique. For spray coating, slurries may have a viscosity of 10 to 30 cP as measured using a LV2 spindle at 60 rpm on a Brookfield viscometer. Being an aqueous system, the viscosity can be easily adjusted by the use of polyionic dispersing agents. Such dispersants can be polyacrylate and polymethacrylate salts and lignosulfonates, with ammonium polyacrylate (e.g., Duramax D-3005 or Darvan 821A) being preferable. A dip coating slurry can be prepared containing approximately
a) 50 wt % of a mixture comprising 75 to 95 wt % electrode powders, 2 to 3% methylcellulose binder, up to 2% starch, up to 2% plasticizer, up to 2% dispersant; and
b) 50 wt % water.

It is preferred if the second electrode, after sintering, is a composite of formula Ni-AZrₐCe_{b}Acc_{c}O_{3-y} where the fraction of Ni in the Ni-AZrₐCe_{b}Acc_{c}O_{3-y} composite is 0.2 to 0.8 on a volumetric or weight basis and the variables are as herein before defined (formula (I)).

Alternatively viewed, it is preferred if the second electrode, after sintering, is a composite of formula Ni-AZrₐCe_{b}Acc_{c}O_{3-y} where the fraction of Ni in the Ni-AZrₐCe_{b}Acc_{c}O_{3-y} composite is 0.2 to 0.8 on a volumetric or weight basis and the variables are as herein before defined (formula (I)).

The porosity of 2nd electrode can be achieved with a similar manner as the 1st electrode. The porosity is achieved by reducing NiO to Ni under reducing conditions at 500-1100° C.

In one embodiment the solvent used to deposit the second electrode is different from the solvent used to deposit the membrane layer. It is important as the subsequent electrode deposition step could dissolve any of the binders used in the membrane formation step.

For example, if the binder used in the membrane coating is soluble in water, the layer will dissolve in water if we dip coat the outer electrode using an aqueous solvent.

Even when dissolution is not an issue, the membrane layer can absorb a solvent and swell. So, even if the green membrane layer does not dissolve, it could swell, causing cracking and delamination.

In a preferred embodiment, water is employed as the solvent for second electrode deposition and an ester as the solvent for the spray coating of the membrane. Additives can be added to the slurries used in the coating process to ensure adjust the solubility of the membrane layer/electrode layer in organic/aqueous solvents.

A current collector may also be applied to one or both of the electrodes. A current collector may be a metal current collector, conveniently Ni.

### Sintering

Once the three layers are formed, the whole assembly can be sintered. In the sintering process, the whole assembly is subject to thermal heat treatment to firstly remove organic components and any water and secondly to densify the assembly. It may be that the heat treatment process is effected in stages.

A lower initial heat treatment step can be used to remove organics that are present. That step can be followed by a higher temperature sintering step to complete the densification process.

The initial heat treatment sinter may be effected at a temperature of 200 to 500° C., such as 250 to 400° C. The process will start at ambient temperature and the rate of temperature increase may be 1 to 5° C. per minute. The sinter may dwell at a temperature in the above range for a period of time.

The sintering temperature to ensure densification of the MEA may be effected at a temperature of at least 1000° C., such as 1100 to 2000° C., e.g. 1200 to 1900° C. Ideally, temperatures up to 1800° C., e.g. 800 to 1700° C., preferably 1000 to 1650° C., e.g. 1200° C. to 1600° C. are used. Again, the rate of temperature increase may be 1 to 5° C. per minute.

Sintering can be done in several different atmospheres, e.g. oxygen, hydrogen, inert gasses such as hydrogen, steam or mixtures such as air or humidified oxygen. Ideally an atmosphere such as air is used. If NiO is present during sintering of a membrane supported on a NiO-cermet and sintering is done under an atmosphere where the NiO is retained in the material, a second reducing step is needed. It is advised that this step is done under reducing conditions such as hydrogen or diluted hydrogen. It is further advised that this is done at a temperature a temperature between 500 and 1200° C., more preferred between 700 and 1100° C., most preferred between 800 and 1000° C. After sintering, it is preferred if each layer of the MEA is essentially free of any organic material.

The electrode layers are ideally porous, letting compounds such as hydrogen penetrate without hindrance. The electrolyte layer is ideally dense.

Alternatively, the individual layers can be sintered separately, such as a first step sintering of the support, a second step where the electrolyte layer is deposited with a following second sintering step, a third step where the second electrode is deposited followed by a third sintering step, wherein the temperature of each sintering step is tuned to reach desired density.

Alternatively, the membrane can be formed simply from the mixed metal oxide and optional support with the dehydrogenation catalyst forming, for example, a matrix within the reactor which the feed passes through. The catalyst may be provided therefore as a particulate bed.

Preferably, the membrane reactor comprises a membrane electrode assembly comprises, in the following layer, order:
(I) a supporting electrode layer comprising a Ni composite of formula Ni-AZrₐCe_{b}Acc_{c}O_{3-y};
(II) a proton conducting membrane layer comprising AZrₐCe_{b}Acc_{c}O_{3-y};
(III) a second electrode layer comprising a Ni composite of formula Ni-AZrₐCe_{b}Acc_{c}O_{3-y};
wherein, for each layer independently, A is Ba, Sr or Ca or a mixture thereof; the sum of a+b+c equals 1;
b is 0-0.75;
c is 0.05-0.5;
Acc is Y, Yb, Gd, Pr, Sc, Fe, Eu,, In or Sm, or a mixture thereof; and y is a number such that formula (I) is uncharged, e.g. 3-y is 2.75 to 2.95.

Preferably, the membrane reactor comprises a membrane electrode assembly comprises, in the following layer, order:
(I) a supporting electrode layer comprising a Ni composite of formula Ni—BaZrₐCe_{b}Y_{c}O_{3-y};
(II) a proton conducting membrane layer comprising BaZrₐCe_{b}Y_{c}O_{3-y};
(III) a second electrode layer comprising a Ni composite of formula Ni—BaZrₐCe_{b}Y_{c}O_{3-y};
wherein, for each layer independently, the sum of a+b+c equals 1;
b is 0-0.75;
c is 0.05-0.5;
and y is a number such that formula (I) is uncharged, e.g. 3-y is 2.75 to 2.95.

Preferably, the membrane reactor comprises a membrane electrode assembly comprises, in the following layer, order:
(I) a supporting electrode layer comprising a Ni composite of formula Ni—BaZrₐCe_{b}Y_{c}YbdO_{3-y};
(II) a proton conducting membrane layer comprising BaZrₐCe_{b}Y_{c}Yb_{d}O_{3-y};
(III) a second electrode layer comprising a Ni composite of formula Ni—BaZrₐCe_{b}Y_{c}YbdO_{3-y};
wherein the sum of a+b+c+d equals 1:
b is 0.05-0.75
c is 0.05-0.25
d is 0.05-0.25; and
y is a number such that formula (I) is uncharged, e.g. 3-y is 2.75 to 2.95.

Preferably, the membrane reactor comprises a membrane electrode assembly comprises, in the following layer, order:
(I) a supporting electrode layer comprising a Ni composite of formula Ni—BaCe_{0.7}Zr_{0.1}Y_{0.1}Yb_{0.1}O_{3-y};
(II) a proton conducting membrane layer comprising BaCe_{0.7}Zr_{0.1}Y_{0.1}Yb_{0.1}O_{3-y};
(III) a second electrode layer comprising a Ni composite of formula Ni—BaCe_{0.17}Zr_{0.1}Y_{0.1}Yb_{0.1}O_{3-y};
wherein, y is a number such that formula (I) is uncharged, e.g. 3-y is 2.75 to 2.95.

### Process Conditions

The process of the invention requires that the starting material is fed in the reactor. The temperature of the feed is such that the materials are fed as gases but typically, the feed will preferably be heated to have the same temperature as the reactor.

The process within the first zone is normally operated at temperatures of 300° C. to 1000° C., preferably 400° C. to 700° C. The pressure within the reactor may range from 0.5 to 50 bar, preferably 6 bar to 30 bar. It is preferred that the heat required in the first zone to effect the dehydrogenation reaction is derived from the Joule heating process occurring in the proton conducting membrane.

In one embodiment, the liquid ammonia and optional water can be pressurized e.g. to a pressure of 5 to 50 bar before entry into the first zone. Heating the compressed liquid readily yields a gaseous reactant feed at the starting temperature.

The protonic membrane removes hydrogen from the first zone and can facilitate a near 100% conversion at temperatures as low as 500° C.

The overall dehydrogenation reaction is endothermic, and conventionally heat can be supplied by heat transfer through the membrane from an exothermic reaction taking place on the permeate side of the membrane between permeated hydrogen and sweep air. This is unattractive as hydrogen, a valuable resource and the point of the process, is wasted.

In the present invention, heat is preferably supplied via ohmic losses and hence Joule energy as discussed further below. We do not need to react the desired hydrogen product with oxygen to generate heat for the dehydrogenation reaction. This maximises the hydrogen production. The proton conducting membrane therefore enables heat management within the system.

Further, compared to using complex metal membranes or less mechanically stable membranes of the prior art, the proton conducting membrane of this invention is stable even in chemically harsh conditions at high temperature. The basic nature of the employed Ba-based proton conductor makes it ideal for ammonia operation.

The reaction products at the outlet of the first zone include nitrogen, any hydrogen which has not passed through the membrane, unreacted ammonia and water if present. Nitrogen does not pass through the proton conducting membrane and can be extracted from the first zone and separated from any other components present. Nitrogen can therefore be extracted and pressurised. This resource can be used in any useful application or the nitrogen might be passed through a heat exchanger to recover heat which in turn can be used to heat the first zone.

The protons (and hence hydrogen) that pass through the proton conducting membrane are electrochemical compressed and this process also generates heat.

It is important therefore that ammonia dehydrogenation is endothermic as the reaction in first zone acts as a heat sink for the heat generated across the proton conducting membrane and during hydrogen compression.

Hydrogen is extracted from the permeate side of the protonic membrane using an external bias allowing for direct compression of the hydrogen gas. The process is not dependent on ΔP_{H2} across the proton conducting membrane other than an increase in overall potential due to the chemical Nernst potential. Additionally, high hydrogen recovery can be obtained as the removal of hydrogen from the permeate side of the proton conducting membrane shifts reaction towards nitrogen.

As hydrogen passes through the membrane, the pressure in the second zone increases. Once the process has started therefore, the partial pressure of hydrogen in the second zone is higher than the partial pressure of hydrogen in the first zone. In particular, the partial pressure of hydrogen in the second zone is at least 2×, such as at least 5× such as at least 15× the pressure in the first zone. Pressures up to 20× or less are possible. The partial pressure of hydrogen in the first zone may be 1-70 bar, or more preferred 5-30 bar or most preferred 10-20 bar.

The reactor may be provided with a pressure regulator at the gas outlet within the second zone. This pressure regulator enables control over the pressure within the second zone by preventing hydrogen that has passed across the membrane from escaping the second zone. Once the process is running, the pressure of hydrogen in the second zone is higher than the pressure of hydrogen in the first zone and can be controlled via the pressure regulator.

The pressure regulator can be used to ensure a particular pressure is achieved within the second zone. Suitable pressures within the second zone are 2 to 700 bars, such as 10 to 350 bars, e.g. 20 to 100 bars.

Joule heating, also known as ohmic heating or resistive heating, is the process by which the passage of an electric current through a conductor releases heat. In the present invention, the ohmic loss during the operation of the membrane will cause Joule heating. The heat generated in this process can be used to provide the heat required for the dehydrogenation.

### Dehydrogenation Catalyst

The membrane reactor used in the present process may employ a separate dehydrogenation catalyst to encourage the dehydrogenation reaction. Any dehydrogenation catalyst capable of achieving the desired process can be used.

In one embodiment, the dehydrogenation catalyst is preferably a porous catalyst that is freely present within the first zone of the membrane reactor. The catalyst can be in the form of powder with tailored particle size. The catalyst is not adhered to the membrane. In this embodiment the catalyst can therefore easily be exchanged if it needs to be regenerated.

The dehydrogenation catalyst is however preferably integrated in the MEA as an electrode. Preferably the Ni containing first electrode defined herein also acts as a dehydrogenation catalyst.

In some embodiments, no catalyst is used at all. In some embodiments, the material used in the membrane has sufficient catalytic activity that no further catalyst is needed.

### Membrane Reactor

In principle any reactor design can be used, however preferred reactor designs are flow-type fixed bed, fluidized bed and wash-coated designs. It is important therefore that there is flow from inlet to outlet in the first zone of the reactor. One advantageous design utilises a reactor within which there is a tubular transport membrane. Between the reactor walls and the tubular membrane is an optional bed of dehydrogenation catalyst. This forms the first zone in the reactor. This bed need not extend the whole length of the reactor but it may. Alternatively, the first zone of the reactor is inside the tube where the catalyst is preferably located.

Ammonia with optionally steam is fed into the first zone. Dehydrogenation occurs on contact between the reactants and any catalyst thus forming hydrogen.

Hydrogen gas generated passes through the membrane and into the second zone of the membrane reactor. Gases which do not pass through the membrane can be collected at the outlet in the first zone.

It is preferred that the distance from the catalyst to the membrane is as short as possible, preferable no more than 5 cm and more preferable less than 5 mm.

It is most preferred that the catalyst is also the electrode in first zone.

It is preferred if hydrogen is removed in a counterflow direction to the flow of the reactant gases.

A sweep gas can optionally be fed to the second zone, permeate side of the membrane. It is preferred if the sweep gas is inert towards hydrogen. It is most preferred if the sweep gas is steam. Steam sweep gas will contribute to the hydration of the membrane and increase the proton conductivity.

The invention will now be defined with reference to the following non limiting examples and figures.

### BRIEF DESCRIPTION OF THE FIGURES

FIG. 1 is a micrograph of a fractured surface showing the structure resulting from the use of a single co-sintering step to produce the MEA architecture. Also included is a porous current collector layer deposited on the cathode surface.

FIG. 2 shows conversion of anhydrous ammonia as a function of hydrogen recovery. Here hydrogen recovery is defined as the percentage of hydrogen measured in the exit of second zone divided by the total hydrogen available from fed NH₃ to the first zone. Zero hydrogen recovery yields the open circuit conversion. It is observed that ammonia conversion increases with increased hydrogen recovery and reaches 100% at a hydrogen recovery of ˜60%

FIG. 3 shows conversion of aqueous ammonia as a function of hydrogen recovery. Here hydrogen recovery is defined as the percentage of hydrogen measured in the exit of second zone divided by the total hydrogen available from fed NH₃ to the first zone. Zero hydrogen recovery yields the open circuit conversion. It is observed that ammonia conversion increases with increase hydrogen recovery and reaches >98% at hydrogen recovery of >95%.

FIG. 4 shows increasing hydrogen partial pressure within the membrane reactor during ammonia dehydrogenation.

FIG. 5 shows a process flow diagram for a 1 tonne/day hydrogen production facility operating on anhydrous ammonia.

FIG. 6 shows a process flow diagram for a 1 tonne/day hydrogen production facility operating on aqueous ammonia (35% NH₃ solution).

### EXAMPLES

### Membrane Preparation:

A tubular asymmetric membrane support of 60 wt % Ni—BaZr_{0.7}Ce_{0.2}Y_{0.1}O_{3-δ} (BCZY27) with a 30 μm dense membrane was synthesized using a reactive sintering approach.

Precursors of BaSO₄, ZrO₂, Y₂O₃ and CeO₂ were mixed in stoichiometric amounts (metal basis) together in a Nalgene bottle on ajar roller for 24 h. The material was dried in air and sieved through a 40 mesh screen. This forms a first precursor mixture.

Two portions of the precursor mixture were mixed additionally with 64 wt. % NiO. One of those portions (the first portion) was then blended with water soluble acrylic and cellulosic ether plasticizer to prepare the extrusion batch.

Green tubes were extruded using the extrusion batch on a Loomis extruder. The extruded tubes were then dried and spray coated with the first precursor mixture.

After a second drying step the tubes were dip coated in a solution of the previous second portion (containing NiO). The tubes were co-fired by hang-firing in air at 1600° C. for 4 h. This process creates an internal NiO-BCZY27 layer. The sintered tubes were then treated in a hydrogen mixture (safe gas) at 1000° C., to reduce the NiO to Ni and give the necessary porosity in anode support structure and outer cathode. A Ni current collector was deposited on the outer cathode. A scanning electrode micrograph of the cell cross section is given in FIG. 1.

### Catalyst:

The anode support structure consisting of 60 wt. % Ni-BCZY27 provides sufficient catalytic activity for ammonia dehydrogenation.

### Cell Assembly:

The ceramic cell above was sealed to a ceramic alumina riser with an outer diameter of ½″ using a glass ceramic seal designed to thermally match the thermal expansion coefficient of the cell assembly. The ceramic riser enables positioning of the ceramic cell in a uniform temperature zone during experiments. The other end of the tubular ceramic cell was capped using a similar glass ceramic sealant material, yielding a leak free cell assembly.

### Reactor and Setup:

The tubular reactor set-up consists of the inner cell assembly and an outer steel reactor tube (Kanthal APMT, ID=20.93 mm). The cell assembly were assembled onto a 316 SS Swagelok-based system providing electrical contact and feedthrough for thermocouples and gases. Thermocouples were placed inside the tubular cell and outside the reactor tube at the top and bottom of the ceramic cell. By utilizing these thermocouples, the heating zones of the reactor furnace were adjusted to an axial temperature difference of less than 10° C. A Ni tube (O.D.=4.6 mm) served as the gas feed and current probe for the inner first zone. To ensure contact between the tubular cell and Ni tube, Ni wool (American Elements) was inserted into the first zone to ensure contact between the Ni tube and first electrode. The outer second electrode was contacted with with Ag wires (diameter=0.25 mm) wrapped around the tubular structure. Gas analysis was performed using an Agilent 7890 gas chromatograph measuring the concentrations of He, H₂, N₂ and NH₃ in the product and sweep outlet gas lines. A Hameg HMP4040 power source was used in galvanostatic mode for the hydrogen removal, compression and production of heat.

### Process 1 Anhydrous NH₃ Dehydrogenation

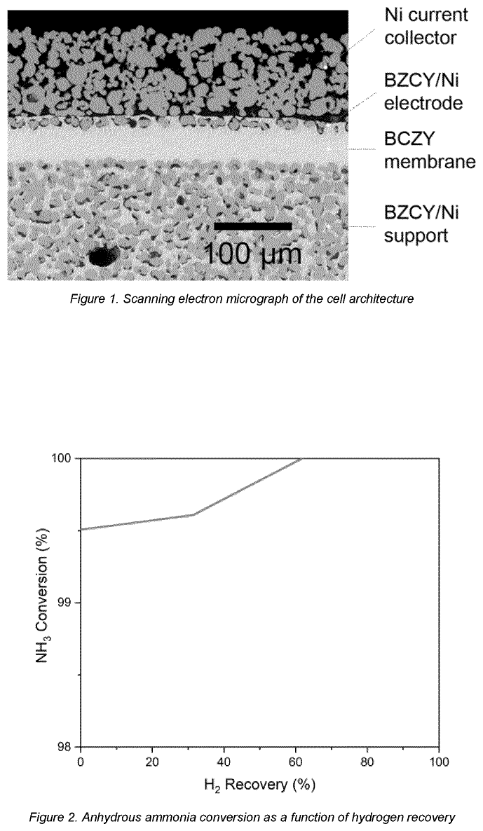

A cell assembly was mounted in the reactor setup, both described above. The active cell area was 32.4 cm². A gas flow consisting of 105 mL/min N₂ and 20 mg/min H₂O was fed to the second zone, while a gas flow consisting of 26.2 mL/min of He and 20 mg/min of NH₃ was fed to the first zone where the dehydrogenation reaction of NH₃ occurs and hydrogen is transported through the membrane when an external bias is applied. The reaction temperature was 600° C. Helium was used as an internal standard and to identify possible leaks through the membrane. The ammonia conversion obtained at open circuit voltage (OCV) was equal to 99.5%. When applying an external electric field of 3.2 A over the membrane the ammonia conversion reached 100%. The ammonia conversion increases with the amount of hydrogen transported through the membrane, corresponding to increasing the current and obtained hydrogen recovery as shown in FIG. 2.

### Process 2 Aqueous NH₃ Dehydrogenation

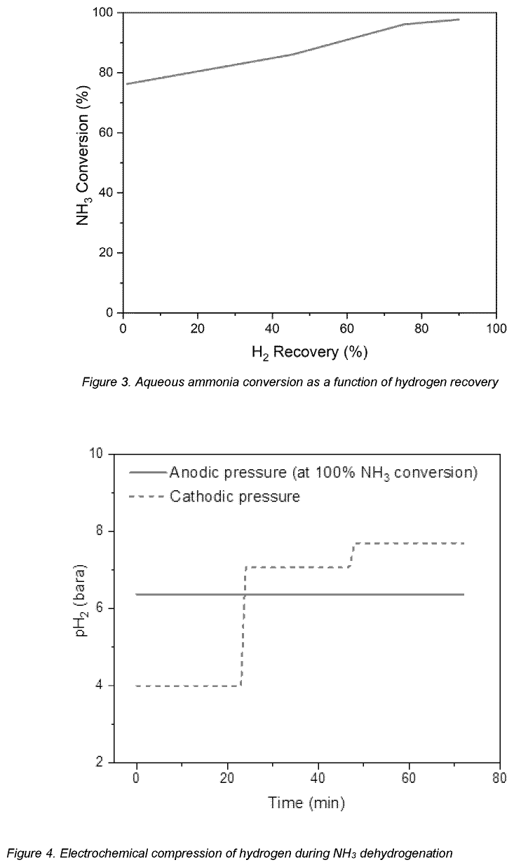

A cell assembly was mounted in the reactor setup, both described above. The active cell area was 15.39 cm². A gas flow consisting of 105 mL/min N₂ and 20 mg/min H₂O was fed to the second zone, while a gas flow consisting of 15.1 mL/min He, 10 mg/min NH₃ and 32 mg/min H₂O, corresponding to a 75% H₂O 25% NH₃ aqueous ammonia mixture was fed to the first zone where the dehydrogenation reaction of NH₃ occurs and hydrogen is transported through the membrane when an external bias is applied. The reaction temperature was 600° C. Helium was used as an internal standard to identify possible leaks through the membrane. The ammonia conversion obtained at open circuit voltage (OCV) was equal to 76%. When applying an external electric field of 3 A over the membrane the ammonia conversion reached 98%. Similarly to the anhydrous case, the ammonia conversion increases with the amount of hydrogen transported through the membrane, corresponding to increasing the current and obtained hydrogen recovery as shown in FIG. 3.

### Electrochemical Compression

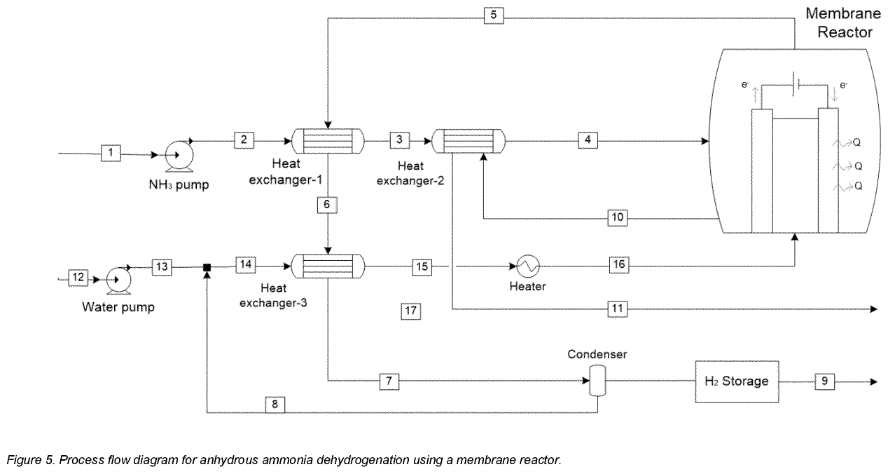

A cell assembly was mounted in the reactor setup, both described above. The active cell area was 14.45 cm². A gas flow consisting of 15.1 mL/min He, 65 mg/min NH₃ was fed to the first zone where the dehydrogenation reaction of NH₃ occurs and hydrogen is transported through the membrane when an external bias is applied. The gas flow in second zone was decreased from 105 mL/min N₂ and 20 mg/min water in two steps, first to 10 mL/min N₂ and 20 mg/min H₂O and then to 20 mg/min H₂O during the experiment. The continuous transport of hydrogen through the membrane allowed for a corresponding increase in hydrogen partial pressure, showing a higher partial pressure of hydrogen in the second zone (cathodic pressure) compared to the first zone (anodic pressure) as shown in FIG. 4.

### Process Flow Diagram 5 Anhydrous Ammonia

For compressed hydrogen production from anhydrous ammonia a process flow diagram is given in FIG. 5.

Anhydrous ammonia is fed via line (1) through a pump to heat exchanger-1. This heat exchanger-1 can be heated via hydrogen extracted in line (5) from the membrane reactor. A second heat exchanger-2 can be used before ammonia passes into the membrane reactor via line (4). Any unreacted starting material and retained nitrogen can be recycled to heat exchanger-2 via line (10) and nitrogen extracted via line (11).

If required water can be added to the permeate side of the reactor via heat exchanger-3 which can also be heated via hydrogen via line (6). The hydrogen water mixture from heat exchanger-3 can be removed and condensed via 7. Water can be recycled and hydrogen taken for storage via line (9). If required water can also be further heated via lines 15 and 16 and the heater there between.

ASPEN software is used to simulate a 1 tonne H₂ per day production facility using process flow diagram described above. Reaction conditions are 650° C. with a reaction pressure of 27.9 bar (giving a hydrogen partial pressure of 20.9 bar assuming full conversion). Produced hydrogen is electrochemically compressed to 25.4 bar. Operating at a current density of 0.517 A/cm² a membrane area of 214 m² is needed. Heat generated by the operation of the membrane, Joule heating, is supplied to the endothermic ammonia dehydrogenation reaction and for heat exchange of fed anhydrous ammonia. The benefit of heat integration yields an overall energy efficiency of 92.1%.

### Process Flow Diagram 6 Aqueous Ammonia

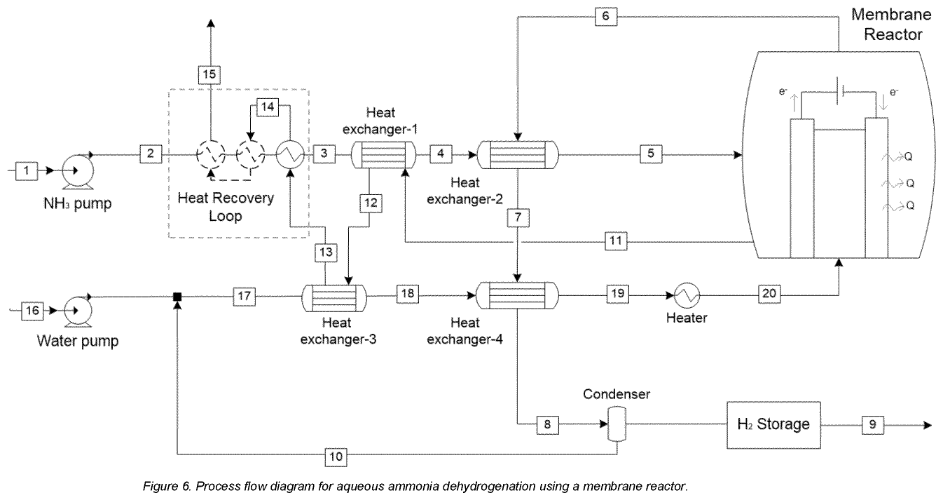

For compressed hydrogen production from aqueous ammonia a process flow diagram is given in FIG. 6.

Aqueous ammonia is fed via line (1) through a pump to line (2) and passes through a series of heat exchangers forming a so called heat recovery loop. Line (3) containing the reaction mixture is fed to heat exchanger-1, which can be heated via line (11) from the retentate of the membrane reactor. A second heat exchanger-2 can be used before aqueous ammonia enters the membrane reactor via line (5). This heat exchanger-2 can be heated via hydrogen extracted in line (6) from the membrane reactor permeate. Any unreacted starting material and retained water and nitrogen can be recycled to heat exchanger-1, heat exchanger-3 and the heat recovery loop via line (11) and the remaining water, nitrogen mixture is extracted via line (15).

If required, water can be added to the membrane via line (17) fed first to heat exchanger-3, which can be heated via the retentate from line (11), followed by heat exchanger-4, which can be heated by line (6) containing a hydrogen water mixture from the permeate. The hydrogen water mixture from heat exchanger-4 can be removed and condensed via 7. Water can be recycled and hydrogen taken for storage via line (9). If required water can also be further heated via lines (19) and (20) and the heater there between.

ASPEN software is used to simulate a 1 tonne H₂ per day production facility using process flow diagram described above. Reaction conditions are 650° C. with a reaction pressure of 27.9 bar (giving a hydrogen partial pressure of 7.3 bar assuming full conversion). Produced hydrogen is electrochemically compressed to 25.4 bar. Operating at a current density of 0.664 A/cm² a membrane area of 167 m² is needed. Heat generated by the operation of the membrane, Joule heating, is supplied to the endothermic ammonia dehydrogenation reaction and for heat exchange of fed aqueous ammonia (35% NH₃ solution). The benefit of heat integration yields an overall energy efficiency of 82.7%.

1. A process for the production of compressed hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone via said gas inlet, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein the membrane reactor comprises a pressure regulator at said product outlet from said second zone so that, in operation, the partial pressure of hydrogen in the second zone is higher than the partial pressure of hydrogen in the first zone.

2. A process for the production of hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein joule heating which occurs during the application of the electric field over said proton conducting membrane is used to heat the first zone.

3. A process for the production of compressed hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein the membrane reactor comprises a pressure regulator at said product outlet from said second zone so that, in operation, the partial pressure of hydrogen in the second zone is higher than the partial pressure of hydrogen in the first zone; and
wherein joule heating which occurs during the application of the electric field over said proton conducting membrane is used to heat the first zone.

4. A process as claimed in any preceding claim wherein temperature in the first zone is 400° C. or more such as 400 to 1000° C.

5. The process as claimed in any preceding claim wherein proton conducting membrane is self-supporting.

6. The process as claimed in any preceding claim wherein the first zone comprises a dehydrogenation catalyst.

7. The process as claimed in any preceding claim wherein the hydrogen in the second zone is compressed and is at a pressure of 2 bar or more.

8. The process as claimed in any preceding claim wherein the hydrogen in the second zone is compressed and the heat generated thereby is used to heat the first zone.

9. The process as claimed in any preceding claim wherein said proton conducting membrane comprises at least one mixed metal oxide of formula (I)
AZrₐCe_{b}Acc_{c}O_{3-y};
wherein, for each layer independently,
A is Ba, Sr or Ca or a mixture thereof; the sum of a+b+c equals 1;
b is 0-0.75;
c is 0.05-0.5;
Acc is Y, Yb, Gd, Pr, Sc, Fe, Eu,, In or Sm or a mixture thereof; and y is a number such that formula (I) is uncharged, e.g. 3-y is 2.75 to 2.95.

10. The process as claimed in any preceding claim wherein the membrane reactor comprises a membrane electrode assembly which comprises, in the following layer, order:
(I) a supporting electrode layer comprising a Ni composite of formula Ni-AZrₐCe_{b}Acc_{c}O_{3-y};
(II) a proton conducting membrane layer comprising AZrₐCe_{b}Acc_{c}O_{3-y};
(III) a second electrode layer comprising a Ni composite of formula Ni-AZrₐCe_{b}Acc_{c}O_{3-y};
wherein, for each layer independently, A is Ba, Sr or Ca or a mixture thereof; the sum of a+b+c equals 1;
b is 0-0.75;
c is 0.05-0.5;
Acc is Y, Yb, Gd, Pr, Sc, Fe, Eu,, In or Sm, or a mixture thereof; and y is a number such that formula (I) is uncharged, e.g. 3-y is 2.75 to 2.95.

11. A process as claimed in any preceding claim wherein water is fed to said first zone together with ammonia.

12. A process as claimed in claim 1-11 wherein feed is aqueous ammonia.

13. A process as claimed in any preceding claim wherein the proton conducting membrane is part of a membrane electrode assembly which comprises, in the following layer, order:
(I) a supporting electrode layer comprising a Ni composite of formula Ni—BaZrₐCe_{b}Y_{c}O_{3-y};
(II) a proton conducting membrane layer comprising BaZrₐCe_{b}Y_{c}O_{3-y};
(III) a second electrode layer comprising a Ni composite of formula Ni—BaZrₐCe_{b}Y_{c}O_{3-y};
wherein, for each layer independently, the sum of a+b+c equals 1;
b is 0-0.75;
c is 0.05-0.5;
and y is a number such that formula (I) is uncharged, e.g. 3-y is 2.75 to 2.95.

14. A process as claimed in any preceding claim wherein the proton conducting membrane is part of a membrane electrode assembly which comprises, in the following layer, order:
(I) a supporting electrode layer comprising a Ni composite of formula Ni—BaZrₐCe_{b}Y_{c}Yb_{d}O_{3-y};
(II) a proton conducting membrane layer comprising BaZrₐCe_{b}Y_{c}Yb_{d}O_{3-y};
(III) a second electrode layer comprising a Ni composite of formula Ni—BaZrₐCe_{b}Y_{c}Yb_{d}O_{3-y};
wherein the sum of a+b+c+d equals 1:
b is 0.05-0.75
c is 0.05-0.25
d is 0.05-0.25; and
y is a number such that formula (I) is uncharged, e.g. 3-y is 2.75 to 2.95.

15. A process as claimed in any preceding claim wherein the proton conducting membrane is part of a membrane electrode assembly which comprises, in the following layer, order:
(I) a supporting electrode layer comprising a Ni composite of formula Ni—BaCe_{0.7}Zr_{0.1}Y_{0.1}Yb_{0.1}O_{3-y};
(II) a proton conducting membrane layer comprising BaCe_{0.7}Zr_{0.1}Y_{0.1}Yb_{0.1}O_{3-y};
(III) a second electrode layer comprising a Ni composite of formula Ni—BaCe_{0.7}Zr_{0.1}Y_{0.1}Yb_{0.1}O_{3-y};
wherein, y is a number such that formula (I) is uncharged, e.g. 3-y is 2.75 to 2.95.

16. A process for the production of hydrogen in a membrane reactor, said membrane reactor comprising a first zone separated by a proton conducting membrane from a second zone, said first zone having a gas inlet and a product outlet and said second zone having a product outlet; said process comprising;
a. feeding a gas comprising ammonia to said first zone via said gas inlet, and allowing a reaction to take place in said first zone so that hydrogen and nitrogen are formed;
b. applying an electric field over said proton conducting membrane;
c. allowing hydrogen to dissociate into electrons and protons to selectivity pass through the proton conducting membrane to said second zone where protons and electrons recombine to form hydrogen in the second zone;
wherein the membrane reactor comprises a membrane electrode assembly which comprises, in the following layer, order:
(I) a supporting electrode layer comprising a Ni composite of formula Ni-AZrₐCe_{b}Acc_{c}O_{3-y};
(II) a proton conducting membrane layer comprising AZrₐCe_{b}Acc_{c}O_{3-y};
(III) a second electrode layer comprising a Ni composite of formula Ni-AZrₐCe_{b}Acc_{c}O_{3-y};
wherein, for each layer independently, A is Ba, Sr or Ca or a mixture thereof; the sum of a+b+c equals 1;
b is 0-0.75;
c is 0.05-0.5;
Acc is Y, Yb, Gd, Pr, Sc, Fe, Eu,, In or Sm, or a mixture thereof; and y is a number such that formula (I) is uncharged, e.g. 3-y is 2.75 to 2.95.

17. A membrane reactor comprising a first zone separated by a membrane electrode assembly from a second zone, said first zone having a gas inlet and a product outlet and said second zone having a product outlet wherein said second zone product outlet is provided with a pressure regulator;
a power source adapted to pass an electric field over the membrane electrode assembly; and wherein said membrane electrode assembly comprises, in the following layer, order:
(I) a supporting electrode layer comprising a Ni composite of formula Ni-AZrₐCe_{b}Acc_{c}O_{3-y};
(II) a proton conducting membrane layer comprising AZrₐCe_{b}Acc_{c}O_{3-y};
(III) a second electrode layer comprising a Ni composite of formula Ni-AZrₐCe_{b}Acc_{c}O_{3-y};
wherein, for each layer independently, A is Ba, Sr or Ca or a mixture thereof; the sum of a+b+c equals 1;
b is 0-0.75;
c is 0.05-0.5;
Acc is Y, Yb, Pr, Eu, Pr, Sc or In, or a mixture thereof; and y is a number such that formula (I) is uncharged, e.g. 3-y is 2.75 to 2.95.
